(19) United States
(12) Patent Application Publication
(10) Pub. No.: US 2007/0112894 A1
(43) Pub. Date: May 17, 2007

(54) Computer system, storage system, management computer, and backup management method

(76) Inventors: Wataru Okada, Odawara (JP); Masahide Sato, Noda (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/330,321

(22) Filed: Jan. 12, 2006

(30) Foreign Application Priority Data
Nov. 15, 2005 (JP) 2005-330752

(51) Int. Cl. G06F 17/30

(52) U.S. Cl. 707/204

(57) ABSTRACT

A computer system includes one or a plurality of host computers, a storage system including a disk device having a data volume for reading and writing data by the host computer, and a management computer for connecting the host computer and the storage system. The storage system obtains a snapshot of the data volume at a specific time point, holds the written journal after the specific time point, recovers the snapshot with the snapshot obtained at the time point near a recovery point, as the base, in the recovery, by applying the journal to the snapshot, specifies the journal depending on the snapshot or journal as a releasing target by using an order relationship used for determining the order between the snapshot, serving as the base, in the recovery, and the journal applied to the snapshot upon releasing the snapshot or journal, and releases the specified depending journal together with the snapshot or journal as a releasing target.

The present application is based on and claims priority of Japanese patent application No. 2005-330752 filed on Nov. 15, 2005, the entire contents of which are hereby incorporated by reference.

### BACKGROUND

The present invention relates to a computer system comprising a host computer, a storage system, and a management computer. More particularly, the present invention relates to the structure of the computer system and a backup management method with the above structure.

In general information systems, the backup enables the recovery of lost data in the data loss due to the failure of a storage device, the data damage by computer virus, and erroneous operation of a user.

Further, a backup or recovery technique using journaling is proposed (refer to, e.g., U.S. Patent Publication No. 2005/0015416 (Patent Document 1)). As disclosed in U.S. Patent Publication No. 2005/0015416, a snapshot (logical image of e.g., full backup or difference backup) of a logical group (hereinafter, referred to as a “journal group”) comprising at least one data volume is obtained at a specific time point, data written to a data volume after that of a journal group is held as a journal (also referred to as “After journal” or “post journal”), and a series of After journals is applied to the obtained snapshot in accordance with the writing order, thereby recovering the data at the specific time point. Generally, this is an example of a technique called Continuous Data Protection (CDP).

Further, in the case of already damaging the data which is recovered by applying the After journal, a method for canceling the application of After journal is also proposed (e.g., U.S. Patent Publication No. 2005/0015416, serving as Patent Document 1). As disclosed in U.S. Patent Publication No. 2005/0015416, data overwritten by applying the After journal is saved, and the data saved to the snapshot after applying the After journal is applied to the original data upon canceling the application of After journal (saved data is rewritten), thereby restoring the data to the snapshot before applying the After journal for a short time. Incidentally, the saved data is referred to as a “Before journal”. Further, when the After journal and the Before journal are not distinguished, the After journal and the Before journal are simply referred to as a “journal”.

The above-mentioned recovery time applying the journal depends on the amount of data of applied journal. As disclosed in U.S. Patent Publication No. 2005/0015416, a plurality of generations of snapshots are periodically obtained and, upon recovering the data at the specific time point, the recovery time is reduced by applying a series of journals, starting from the snapshot obtained near the time.

In the backup using the journaling, the amount of journal to be held increases, depending on the amount of written data. Since the capacity of journal volume for storing the journal is finite, the journal volume is completely used in time. Therefore, a technique for releasing (deleting) the old journal is proposed. U.S. Patent Publication No. 2005/0015416 as mentioned above discloses a journal releasing system for maintaining the state to apply journals after an unnecessary journal to the snapshot by applying the unnecessary journal to a just-before snapshot and then releasing the journal, upon releasing the unnecessary journal.

Generally, in the backup using the journaling, the amount of journal to be held is increased, depending on the length of a period for which the recovery using the journal is possible (e.g., 24 past hours). Therefore, the backup using the journaling is not suitable to mid- and long-term backup. Then, when the journal cannot be stored in a journal volume having a predetermined capacity, the operation in cooperation with full backup or difference backup is desired that the journals are released, starting from the old journal, at the recovery time, the recovery using the journal is performed only within the range which can be recovered by using the remaining journals, and the data therebefore is recovered only by using the obtained snapshot at a specific time point. For example, such a cooperation operation that the data which can be recovered by using the remaining journals in a journal volume whose capacity is 10 GB is recovered by using the journals, and the data therebefore is recovered by the snapshot (e.g., full backup) obtained at 12 o'clock every day. The journal releasing system disclosed U.S. Patent Publication No. 2005/0015416 as mentioned above cannot be applied to the cooperation operation because one snapshot of the journal group at one specific time-point is updated to another snapshot at another specific time-point. On the other hand, when the journal is released without updating the snapshot, the journal (hereinafter, referred to as the “journal depending on the journal as a releasing target”) used only for the snapshot after applying the journal as a releasing target becomes an unavailable journal. Thus, there is a problem that the unavailable journal unnecessarily shares the journal volume.

Similarly, the backup using the journaling periodically obtains a plurality of generations of snapshots. However, the volume for storing the snapshot is finite, an old snapshot needs to be released to obtain a new snapshot. However, the old snapshot is simply released and, then, the journal (hereinafter, referred to as the “journal depending on the snapshot as a releasing target”) which can be applied only to the snapshot becomes an unavailable journal without any applying destinations. Thus, there is a problem that unavailable journal unnecessarily shares the journal volume.

### SUMMARY

The present invention is devised to solve the above-mentioned problem. It is an object of the present invention to provide a computer system and a backup management method, in which a journal volume can effectively be used by releasing the snapshot or the journal together with the journal depending on a releasing target (journal depending on the journal as a releasing target or journal depending on the snapshot as a releasing target), or by forming the journal corresponding to the journal depending on a releasing target so as to maintain a recovery point and thereafter releasing the formed snapshot or journal together with the journal depending on a releasing target.

According to the present invention, a computer system includes one or a plurality of host computers, a storage system including a disk device having a data volume for reading and writing data by the host computer, and a management computer for connecting the host computer and the storage system. The storage system obtains a snapshot of the data volume at a specific time point, holds the written journal after the specific time point, recovers the data at a specific point in time by applying the journal to the snapshot which was obtained at the time point near the specific point in time, specifies the journal depending on the snapshot or journal as a releasing target by using an order relationship used at the recovery to determine the order of the snapshot to which the journals are applied and the journals to be applied upon releasing the snapshot or journal, and releases the specified depending journal together with the snapshot or journal as a releasing target.

According to the present invention, upon releasing the journal or snapshot, an unavailable journal does not remain in the journal volume and, therefore, the journal volume can effectively be used.

### BRIEF DESCRIPTION OF THE DRAWINGS

FIG. 1 is a diagram showing the system structure according to a first embodiment;

FIG. 2 is a diagram showing an example of the structure of a journal volume according to the first embodiment;

FIG. 3 is a diagram showing one example of a journal volume table according to the first embodiment;

FIG. 4 is a diagram showing another example of the journal volume table according to the first embodiment;

FIG. 5 is a diagram showing an example of a snapshot table according to the first embodiment;

FIG. 6 is a diagram showing an example of an application table according to the first embodiment;

FIG. 7 is a diagram showing an example of a snapshot management table according to the first embodiment;

FIG. 8 is a diagram showing an example of a storage table according to the first embodiment;

FIG. 9 is a diagram showing a rule table according to the first embodiment;

FIG. 10A is a diagram showing an example of a screen for setting information on a storage device displayed on a setting program according to the first embodiment;

FIG. 10B is a diagram showing an example of screen for setting information on application as a backup target displayed on the setting program according to the first embodiment;

FIG. 11 is a diagram showing the operation of processing for setting the information on the application as a backup target on the setting program according to the first embodiment;

FIG. 12 is a diagram showing processing for obtaining a snapshot on a backup program according to the first embodiment;

FIG. 13 is a diagram showing processing for releasing the snapshot of a snapshot/JNL management program according to the first embodiment;

FIG. 14 is a diagram showing an example of a rule for determining whether or not the recovery point is maintained according to the first embodiment;

FIG. 15 is a diagram showing processing for monitoring the amount of used journal of a JNL releasing program according to the first embodiment;

FIG. 16 is a diagram showing processing for releasing the oldest journal on the snapshot/JNL management program according to the first embodiment;

FIG. 17 is a diagram showing the system structure according to a second embodiment;

FIG. 18 is a diagram showing processing for ensuring a journal storage area on a writing monitoring program according to the second embodiment;

FIGS. 19A and 19B are explanatory diagrams of examples of processing for releasing a journal as a releasing target according to the embodiments of the present invention; and

FIGS. 20A and 20B are explanatory diagrams of examples of processing for releasing a snapshot as a releasing target according to the embodiments of the present invention.

### DESCRIPTION OF THE PREFERRED EMBODIMENTS

Preferred embodiments of the present invention will be described.

Hereinlater, a description is given of a computer system, a storage system, a management computer, and a backup management method according to embodiments of the present invention with reference to the drawings. Incidentally, this does not limit the present invention.

According to the embodiments of the present invention, a storage system having a control unit for controlling the backup and the restoration using the journaling, and includes a snapshot/JNL management program and a recovery point management information. Further, a management computer for managing the backup and restoration using the journaling contains a setting program, a backup program, and a JNL releasing program. The storage system according to the present invention comprises one or a plurality of storage devices and, hereinlater, the storage system is described as the storage device in some cases.

On the setting program, upon releasing a snapshot or journal, a rule for determining whether or not a corresponding journal is formed so as to maintain the recovery point of the journal depending on a releasing target is registered to the recovery point management information.

Upon obtaining a new snapshot, the backup program requests the releasing operation of the existing snapshot to the snapshot/JNL management program. The snapshot/JNL management program receives the request, specifies a journal depending on a snapshot as a releasing target by using the order relationship used at the recovery to determine the order of the snapshot to which the journals are applied and the journals to be applied upon releasing the snapshot or journal, forms a corresponding journal in the case of maintaining the recovery point in accordance with the rule registered in the recovery point management information, releases the corresponding journal together with the snapshot as a releasing target.

Upon releasing the journal, the JNL releasing program requests the releasing operation of the journal to the snapshot/JNL management program. The snapshot/JNL management program receives the request, specifies a journal depending on a journal as a releasing target by using the snapshot, serving as the base, at the recovery time and the order relationship used for determining the order of journals used for the snapshot, forms the corresponding journal in the case of maintaining the recovery point in accordance with the rule registered in the recovery point management information, and releases the depending journal together with the snapshot as a releasing target.

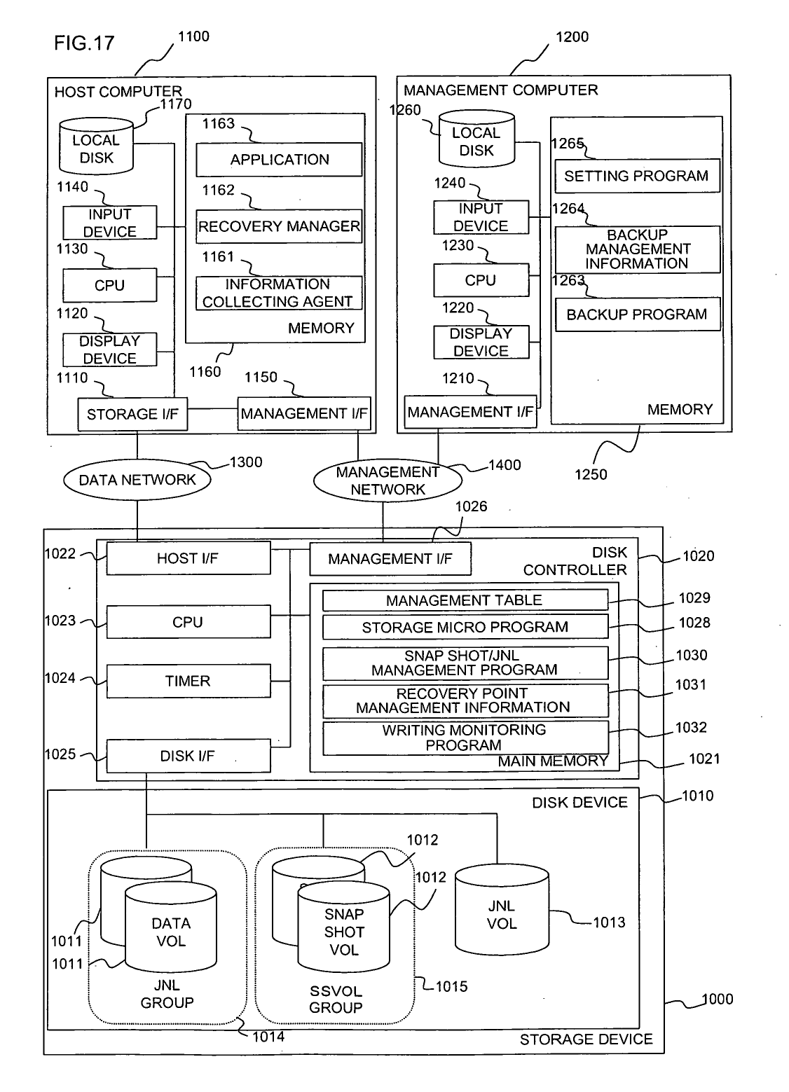

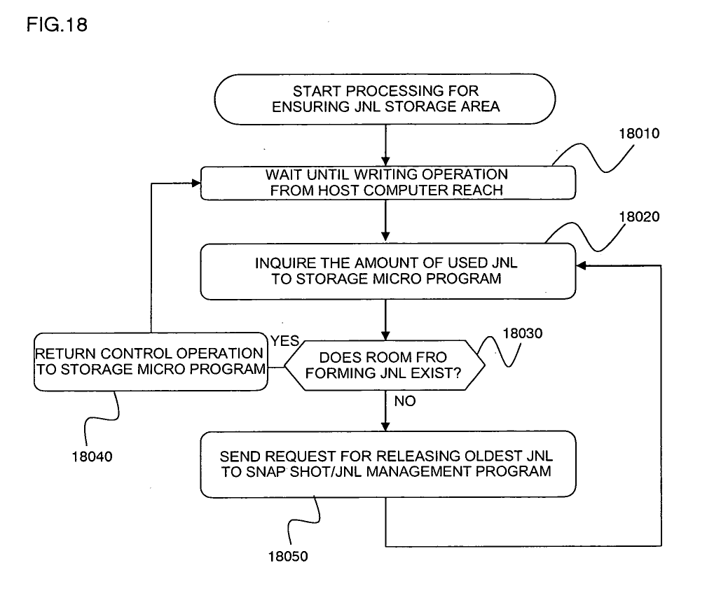

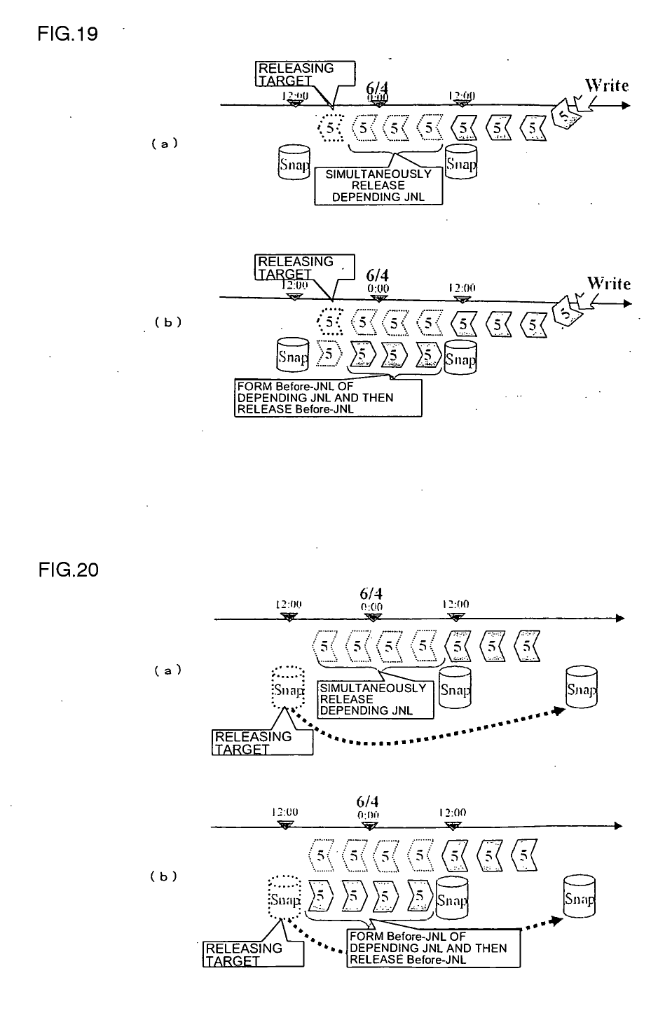

Hereinlater, a description is given of examples of processing for releasing the journal according to the embodiments of the present invention with reference to FIGS. 19A and 19B. Referring to FIG. 19A, the Before journal is not formed, and the journals depending on the journal as a releasing target are specified and are simultaneously released. The depending journal is a journal which becomes unavailable by releasing the journal as a releasing target. Thus, the amount of held journal can be reduced. Referring to FIG. 19B, the Before journal is formed, the journals depending on the journal as a releasing target are specified, and the Before journal is formed in the releasing operation. Thereafter, the depending journal is released. The two processing can be switched in accordance with user's policy and a free capacity of the journal volume.

Hereinlater, a description is given of examples of processing for releasing the snapshot according to the embodiments with reference to FIGS. 20A and 20B. Referring to FIG. 20A, the Before journal is not formed, and the snapshot depending on the journal as a releasing target and is specified and is simultaneously released. The depending journal is a journal which becomes unavailable by releasing the snapshot as a releasing target. Thus, the amount of held journal can be reduced. Referring to FIG. 20B, the Before journal is formed, the snapshot depending on the journal as a releasing target, and the Before journal is formed in the releasing operation. Thereafter, the depending journal is released. The two processing can be switched in accordance with user's policy and a free capacity of the journal volume. The snapshot as a releasing target is released upon forming a new snapshot.

Incidentally, in the description according to the embodiments, the time point designated by a manager upon recovering the data at the specific time is referred to as a “recovery point”. A relationship between the last applied journal of the journals applied to the snapshotupon recovering the data at the recovery point designated by a manager and the recovery point is referred to as “(the) journal has (the) recovery”. When the recovery is accomplished without applying the journal to the snapshot, a relationship between the snapshot and the designated recovery point is referred to as “(the) snapshot has (the) recovery point”. Further, in the case of applying a specific journal, a journal formed by saving the data at the overwriting position for canceling the application is referred to as a “corresponding journal” or “saved journal”.

### First Embodiment

(1) System Structure According to First Embodiment

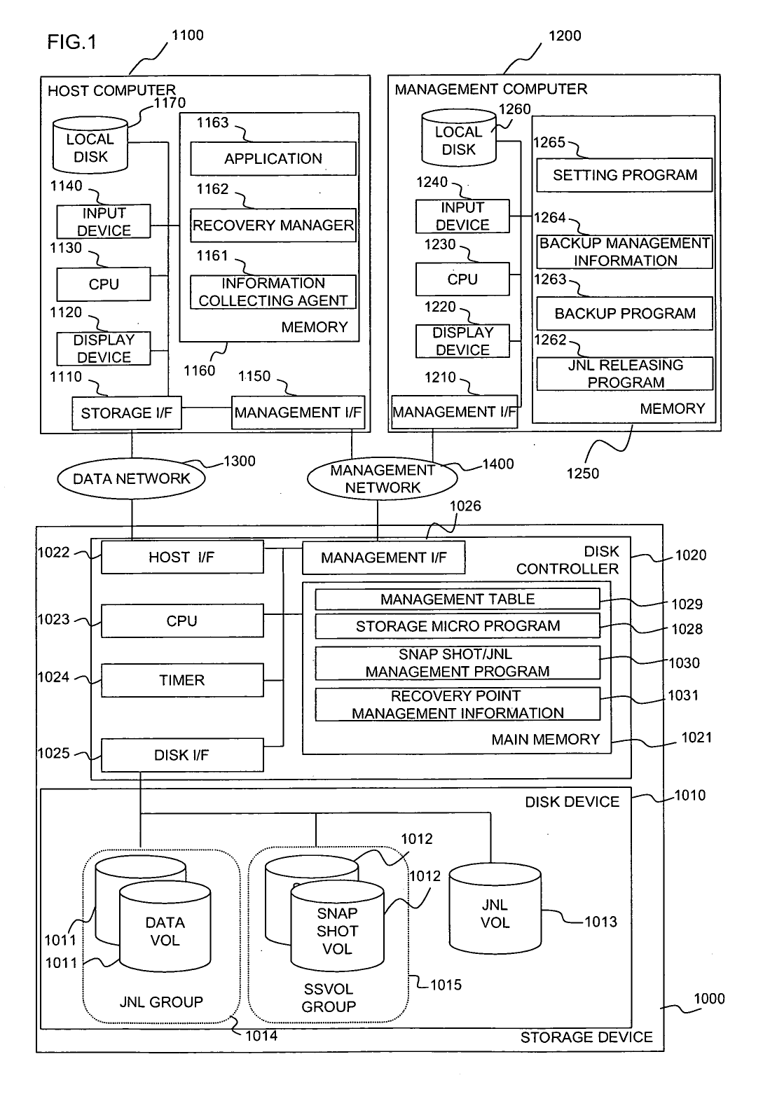

FIG. 1 is a block diagram showing the structure of a computer system according to a first embodiment of the present invention. In the computer system, a storage device 1000 and a host computer 1100 are connected via a data network 1300. According to the first embodiment, the data network 1300 is a storage area network and, however, may be an IP network or a network for data communication except for the storage area network and the IP network.

The storage device 1000 and the host computer 1100 are connected via a management network 1400 to a management computer 1200. According to the first embodiment, the management network 1400 is an IP network and, however, may be a storage area network or a network for data communication except for the storage area network and the IP network. Further, the data network 1300 and the management network 1400 may be the same network and the management computer 1200 and the host computer 1100 may be the same computer. Incidentally, for the convenience of description, referring to FIG. 1, the number of the storage device 1000 is one, the number of the host computer 1100 is one, and the number of the management computer 1200 is one. However, the numbers of the storage device 1000, the host computer 1100, and the management computer 1200 are not limited to those according to the present invention.

The storage device 1000 comprises: a disk device 1010 for storing data; and a disk controller 1020 for control operation in the storage.

The disk device 1010 comprises: a journal group 1014; an SSVOL group 1015; and a journal volume 1013.

The journal group 1014 comprises at least one data-volume 1011. The data volume 1011 contains a logical volume for storing data used by the host computer 1100. A storage micro program 1028, which will be described later, stores the After journal, to which a proper order-number is added in accordance with a writing order, written from the host computer 1100 to the data volume 1011 of the journal group 1014 into the journal volume 1013 associated with the journal group 1014.

The SSVOL group 1015 stores a copy image (snapshot) of the journal group 1014 at an arbitrary time point. Referring to FIG. 1, to the single journal-group 1014, only one (one generation) SSVOL group 1015 is shown. However, in response to the request from a manager, to one journal group 1014, a plurality of (a plurality of generations) SSVOL groups 1015 can be arranged. The SSVOL group 1015 comprises at least one snapshot volume 1012. The snapshot volume 1012 stores a copy image of the data volume 1011 at an arbitrary time point. Incidentally, the copy image stored in the snapshot volume 1012 may be an image for full backup of the data volume 1011 or a logical image for difference backup, in accordance with a request to the system or mounting.

The journal volume 1013 is a volume for storing the After journal and the Before journal. The structure of the journal volume 1013 will be described later.

Incidentally, for convenience of the description, as shown in FIG. 1, the number of the journal group 1014 is one and the number of the journal volume 1013 is one. However, the numbers of the journal group 1014 and the journal volume 1013 are not limited to those according to the present invention.

The disk controller 1020 comprises: a host I/F 1022; a management I/F 1026; a disk I/F 1025; a main memory 1021; a CPU 1023; and a timer 1024.

The main memory 1021 stores a management table 1029, the storage micro program 1028, the snapshot/JNL management program 1030, and a recovery-point management information 1031. The CPU 1023 executes various programs stored in the main memory 1021.

The storage micro program 1028 controls various functions of the backup and recovery using the journaling as described above in the conventional art, including e.g., acquisition of the snapshot, generation of the After journal and the Before journal, and the recovery using the journals. In this case, the storage micro program 1028 performs the control operation while referring and updating information in the management table 1029. The storage micro program 1028 controls the input/output of data to/from the disk device 1010 and performs various operation including the setting and presentation of control information the storage device 1000, in response to a request from the management computer 1200 and the host computer 1100. Incidentally, according to the embodiments, a description is given by using a program as a subject in some cases. However, actually, a processing unit (the CPU 1023 in the storage device 1000, a CPU 1130 of the host computer 1100, and a CPU 1240 of the management computer 1200) for executing the program executes the processing.

The timer 1024 is a general timer having a function for presenting the current time. Upon forming the After journal and obtaining the snapshot, the timer 1024 is referred to by the storage micro program 1028.

The snapshot/JNL management program 1030 releases a snapshot or a journal in response to a request from a backup program 1263 and a JNL releasing program 1262, which will be described later. In this case, the snapshot/JNL management program 1030 specifies a journal depending on a releasing target, and releases the specified journal together with the releasing target or releases the specified journal after forming the journal corresponding to the specified journal for maintaining the recovery point together with the releasing target, in accordance with the recovery point management information 1031, which will be described later.

The host I/F 1022 is an interface (I/F) to the data network 1300, and receives and sends data and a control command to/from the host computer 1100. The management I/F 1026 is an interface (I/F) to the management network 1400, and receives and sends data and a control command to/from the host computer 1100 and the management computer 1200. A disk I/F 1025 is an interface (I/F) to the disk device 1010, and receives and sends data and a control command.

A description will be given of the structure of a management table 1029 and the structure of the recovery-point management information 1031 hereinafter.

The host computer 1100 comprises: an input device 1140 such as a keyboard or a mouse; the CPU 1130; a display device 1120 such as a CRT; a memory 1160; a storage I/F 1110; a management I/F 1150; and a local disk 1170.

The storage I/F 1110 is an interface (I/F) to the data network 1300, and receives and sends data and a control command to/from the storage device 1000. The management I/F 1150 is an interface (I/F) to the data network 1300, and receives and receives data and a control command to/from a management computer 1200 and the storage device 1000 for system management.

The memory 1160 contains an application 1163, a recovery manager 1162, and an information collecting agent 1161, which are executed by the CPU 1130.

The application 1163 reads and writes data to/from the data volume 1011, e.g. DBMS or a file system.

The recovery manager 1162 requests the acquisition of the snapshot to the storage micro program 1028, further requests a recovering request of data at a specific time to the storage micro program 1028, and stops the application 1163. The functions are provided by a command line interface (I/F) (hereinafter, referred to as “CLI”) for the purpose of execution from the manager or another program. The recovery manager 1162 has a function for setting the backup using the journaling to the management table 1029 via the data network 1300, and the manager provides a CLI for using the setting function.

The local disk 1170 is a disk device, such as a hard disk, which is directly connected to the host computer 1100, and stores a system structure defining file (not shown), etc. The system structure defining file describes system structure definitions as the application 1163 uses which data volume 1011 and as the data volume 1011 belongs to the journal group 1014. The system structure defining file is described by the manager in the system structure, e.g., a /etc/fstab file used for general Linux (registered trademark) operating system.

The information collecting agent 1161 is a program for collecting system structure information of the host computer 1100. The information collecting agent 1161 specifies the storage device 1000 and the journal group 1014 of the journal group 1014 used by the application 1163 from the system structure defining file stored in the local disk 1170 in response to a request from a setting program 1265 of the management computer 1200, which will be described later, and returns an identifier of the specified storage device 1000 and an identifier of the journal group 1014 to the setting program 1265.

Incidentally, for convenience of a description, the number of the application 1163 is one in FIG. 1. However, the present invention is not limited to this.

The management computer 1200 comprises: an input device 1240 such as a keyboard or a mouse; a CPU 1230; a display device 1220 such as a CRT; a memory 1250; a local disk 1260; and a management I/F 1210 for receiving and sending data and a control command to/from the host computer 1200 and the storage device 1000 for the purpose of system management.

The memory 1250 of the management computer 1200 stores the setting program 1265, the backup management information 1264, the backup program 1263, and the JNL releasing program 1262. The CPU 1230 realizes the functions by executing the programs stored in the memory 1250.

The setting program 1265 provides a graphical user interface (I/F) (GUI) for setting management information of the computer system, and sets the recovery point management information 1031 and the backup management information 1264 based on values inputted to GUI.

Similarly to the conventional backup software, the backup program 1263 obtains a new snapshot in accordance with a backup schedule defined by the manager. However, when the SSVOL group 1015, serving as the storage destination of the new snapshot, has already stored the snapshot, the backup program 1263 requests the release operation of the stored snapshot to the snapshot/JNL management program 1030 and then obtains the new snapshot.

The JNL releasing program 1262 periodically inquires the amount of used journal volume to the storage micro program 1028. When the amount of used journal volume is a predetermined threshold, the JNL releasing program 1262 requests the release operation of the journal to the snapshot/JNL management program 1030.

The local disk 1260 is a disk device, such as a hard disk, which is directly connected to the management computer 1200, and stores a rule defining file (not shown). The rule defining file defines a rule for determining whether or not the journal corresponding to the depending journal is formed to a releasing target so as to maintain the recovery point, upon releasing the snapshot and the journal. For example, “CDP applying time=past 24 hours” is described and this means that “the corresponding journal is formed when the journal having the recovery point within the past 24 hours from the current time depends on the releasing target”.

The structure of the backup management information 1264 will be described later.

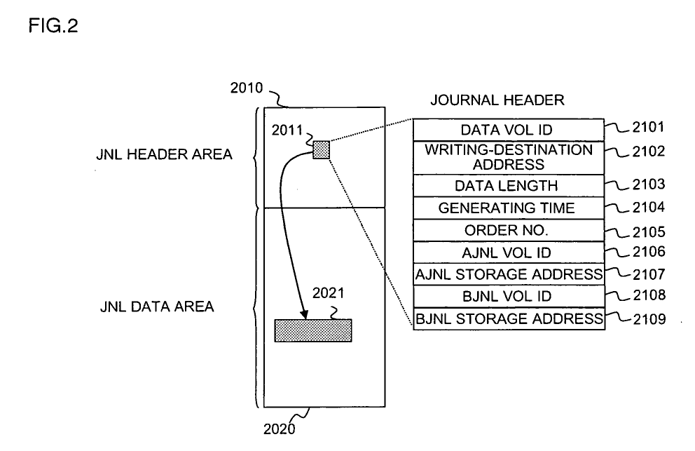

FIG. 2 shows an example of the structure of the journal volume 1013 according to the first embodiment. The journal volume 1013 is logically divided into a journal header area 2010 and a journal data area 2020.

Upon storing the journal in the journal volume 1013, the journal is divided into a journal header 2011 and a journal data 2021. Then, the journal header 2011 and the journal data 2021 are stored in the journal volume 1013. The journal header 2011 is stored in the journal header area 2010, and the journal data 2021 is stored in the journal data area 2020.

The journal data 2021 is written to the data volume 1011 upon applying the journal. The journal header 2011 holds information on the journal data 2021.

The journal header 2011 includes: a data volume ID 2101; a writing-destination address 2102; a data length 2103; a generating time 2104; an order number 2105; an AJNL volume ID 2106; an AJNL storage address 2107; a BJNL volume ID 2108; and a BJNL storage address 2109.

The data volume ID 2101 holds an identifier of the data volume 1011, serving as the writing destination of journal data upon applying the journal. The writing-destination address 2102 holds an address, serving as the writing destination of the journal data upon applying the journal. The data length 2103 holds the length of the written data. The storage micro program 1028 analyzes the writing request from the host computer 1100, thereby obtaining and setting the values.

The generating time 2104 holds a reach time of a writing request from the host computer 1100 to the storage device 1000. The storage micro program 1028 obtains and sets a value of the generating time 2104 from the timer 1024 of the disk controller 1020. The generating time 2104 becomes the recovery point designated by the manager in the recovery. Incidentally, according to another embodiment, the generating time 2104 may be writing and issuing time included in the writing request. For example, under the environment of a main frame, a plurality of main frames share the timer which provides the time for issuing the writing command and, therefore, can be used.

The order number 2105 holds the order number for determining which journals need to be applied to which snapshot in the recovery. The storage micro program 1028 obtains and sets a value of the order number 2105 that is held by the order counter 3003 of a journal group table 3000, which will be described later, upon forming the After journal in accordance with the writing operation from the host computer 1100.

The AJNL volume ID 2106 holds an identifier of the volume of the journal data of the After journal. The AJNL storage address 2107 holds an address for storing the journal data of the After journal. The values are set by the storage micro program 1028, upon forming the After journal. In the case of releasing the journal data of the After journal, the storage micro program 1028 sets NULL to the AJNL volume ID 2106, and further sets NULL to the AJNL storage address 2107.

The BJNL volume ID 2108 holds an identifier of the volume for storing the journal data of the Before journal. The BJNL storage address 2109 holds an address for storing the journal data of the Before journal. The values are set by the storage micro program 1028 upon forming the Before journal. In the case of releasing the journal data of the Before journal, the storage micro program 1028 sets NULL to the BJNL volume ID 2108, and further sets NULL to the BJNL storage address 2109.

All the AJNL volume ID 2106, the AJNL storage address 2107, the BJNL volume ID 2108, and the BJNL storage address 2109 are NULL, the storage micro program 1028 releases the journal header.

The journal header 2011 is formed in accordance with the writing operation from the host computer 1100, only when the storage micro program 1028 forms the After journal, as will be described later. That is, upon forming the Before journal, an identifier of the volume for storing the journal data 2021 of the Before journal is set to the BJNL volume ID 2108, and the stored address is set to the BJNL storage address 2109. Similarly, in the case of forming again the After journal which has been released once, an identifier of the volume for storing the journal data 2021 of the After journal is set to the AJNL volume ID 2106 and the stored address is set to the AJNL storage address 2107.

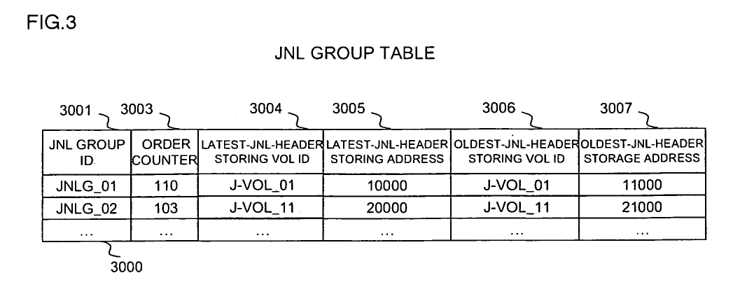

FIGS. 3 to 5 are tables forming the management table 1029. Referring to FIG. 3, the journal group table 3000 forms the management table 1029. The journal group table 3000 comprises: a JNL group ID 3001 for holding an identifier of the journal group; an order counter 3003; a latest-JNL-header storing VOLID 3004 for holding an identifier of a storage volume of the latest journal-header; a latest-JNL-header storing address 3005 for holding a storage address of the latest journal header; the oldest-JNL-header storing VOLID 3006 for holding an identifier of a storage volume of the oldest journal-header; and an oldest-JNL-header storage address 3007 for holding a storage address of the oldest journal-header.

A value of the JNL group ID 3001 is set by the manager by using a CLI provided by the recovery manager 1162. For example, the manager issues a command, such as “CreateJG-idJNLG_01”. The command indicates a request for forming the journal group of an identifier JNLG_01. The value JNLG_01 is stored in the JNL group ID 3001.

The order counter 3003 is a number for managing the forming order of the journal and the snapshot. A value of the order counter 3003 is incremented by one by the storage micro program 1028 each time for generating the After journal in accordance with the writing operation from the host computer 1100. The incremented value is copied to the order number 2105. The value of the order counter 3003 is copied to an order number 5003 of a snapshot table 5000, which will be described later, by the storage micro program 1028 each time for obtaining the snapshot. The processing enables an order relationship between the snapshot and the journal to be recorded. In the recovery, the journals to be applied to the snapshot can be specified. Specifically, upon recovering a specific snapshot by applying the After journal, the recovery is performed by applying, in accordance with the order number, the journal having the order number which is that of the journal having the recovery point of the designated journal or less and is larger than the order number of the snapshot. On the contrary, upon applying the Before journal to a specific snapshot, the recovery is performed by applying, in the order of a larger order number, the journals having the order number which is that of the snapshot or less and which is larger than the order number of the journal having the designated recovery point.

The latest-JNL-header storing VOLID 3004, the latest-JNL-header storing address 3005, the oldest-JNL-header storing VOLID 3006, and the oldest-JNL-header storage address 3007 are used to determine the volume or address for storing a new journal header and to specify a journal to be deleted, and are updated by the storage micro program 1028 upon forming a new journal-header or deleting the journal.

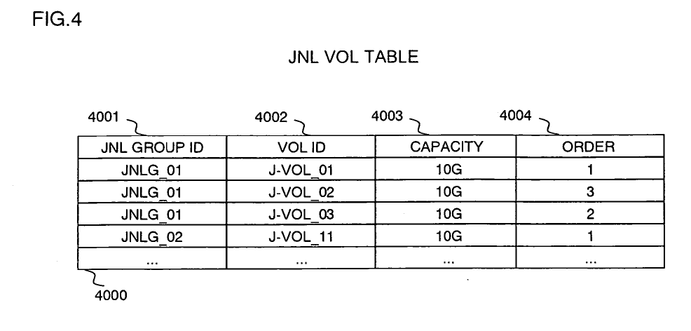

FIG. 4 shows an example of a journal volume table 4000 forming the management table 1029. The journal volume table 4000 shows the journal volume associated with the journal group. The journal volume table 4000 comprises: a JNL group ID 4001 for holding an identifier of the journal group; a volume ID 4002 for holding an identifier of the volume associated with the journal group; a capacity 4003 for holding the storage capacity of the volume; and an order 4004.

A value of the order 4004 prescribes the order of using the journal volume associated with the JNL group ID 4001. At JNLG_01 shown in FIG. 4, the storage micro program 1028 completely uses JVOL_01 and subsequently uses J-VOL_03. In the case of completely using the last volume, the storage micro program 1028 circulatorily uses the volumes by reusing the first volume.

The manager associates the volume ID 4002 with the JNL group ID 4001 by using a CLI provided by the recovery manager 1162. For example, the manager issues a command “addJVOL-jgid JNLG_01-jvolid J-VOL_01”. The command indicates a request for adding the volume an identifier J-VOL_01 to the journal group of the identifier JNLG_01. JNLG_01 is stored in the JNL group ID 4001, and a value of J-VOL_01 is stored in the volume ID 4002. In the case of associating a plurality of volumes with a single journal-group, the command is executed plural times by changing the ID of the volume. Incidentally, a value of the order 4004 allocates natural numbers in the order of 1, 2, 3 . . . , in accordance with the order for correlating the volumes (issuing the commands) every journal group. The capacity 4003 sets the capacity of the volume identified by a value of the volume ID 4002 by obtaining the volumes from the storage micro program 1028.

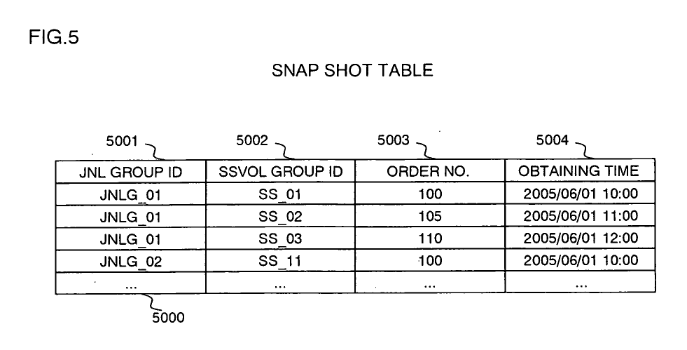

FIG. 5 shows an example of the snapshot table 5000 forming the management table 1029. The snapshot table 5000 manages the obtained snapshot. The snapshot table 5000 includes: a JNL GROUP ID 5001 for holding an identifier of a journal group, serving as an obtaining target; an SSVOL group ID 5002 for holding an identifier of the SSVOL group for storing the snapshot; the order number 5003 indicating the obtaining order of the snapshot; and obtaining time 5004.

The manager associates the JNL group ID 5001 with the SSVOL group ID 5002 to obtain a corresponding relationship between the JNL group ID 5001 and the SSVOL group ID 5002 by using a CLI provided by the recovery manager 1162. For example, the manager issues a command “addSSVOLG-jgid JNLG_01-ssvolgid SS_01”. The command indicates a request for adding an SSVOL group having an identifier SS_01 to the journal group of an identifier JNLG_01. The JNL group ID 5001 stores JNLG_01, and the SSVOL group ID 5002 stores a value of SS_01. Incidentally, in the case of setting snapshots of a plurality of generations, the command is executed plural times. The order number 5003 is copied from the order counter 3003 of the journal group table 3000 every acquisition of the snapshot by the storage micro program 1028.

The obtaining time 5004 holds reach time of the request for obtaining the snapshot from the recovery manager 1162 to the storage device 1000. Similarly to the generating time 2104 of the journal header, a value of the obtaining time 5004 is obtained and is set from the timer 1024 of the disk controller 1020 or a request for obtaining the snapshot by the storage micro program 1028.

Incidentally, upon releasing the snapshot, the storage micro program 1028 sets NULL to the order number 5003 and the obtaining time 5004.

The above examples show the tables forming the management table 1029.

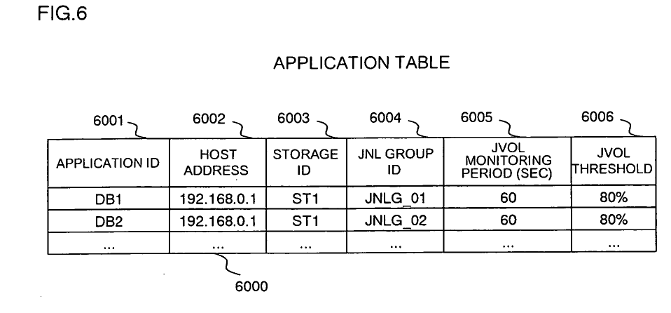

FIGS. 6 to 8 show examples of tables forming the backup management information 1264. FIG. 6 shows an application table 6000 forming the backup management information 1264. The application table 6000 stores information for backup management, and comprises: an application ID 6001 for holding an application identifier as a backup target; a host address 6002 for holding an identifier of the host computer on which an application, such as an IP address, starts; a storage ID 6003 for holding an identifier of the storage of the journal group used by the application; a JNL group ID 6004 for holding an identifier of the journal group used by the application; a JVOL monitoring period 6005 for holding a period for monitoring the amount of used journal volume; and a JVOL threshold 6006 for holding a value indicating the amount of used journal volume for starting the journal.

The manager sets values of the application ID 6001, the host address 6002, the JVOL monitoring period 6005, the JVOL threshold 6006 via the GUI provided by the setting program 1265.

The storage ID 6003 and the JNL group ID 6004 indicate a corresponding relationship between the journal groups used by the application, and information obtaining from the information collecting agent 1161 by the setting program 1265. The storage ID 6003 uniquely identifies the storage device, such as serial No.

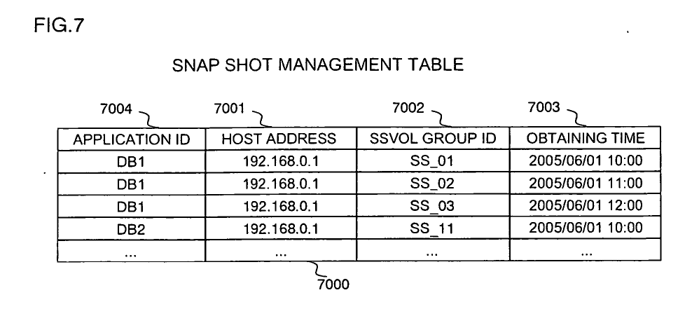

FIG. 7 shows an example of a snapshot management table 7000 forming the backup management information 1264. The snapshot management table 7000 stores information for managing the snapshot, and comprises: an application ID 7004 for holding an identifier of an application, serving as an obtaining target of the snapshot; a host address 7001 for holding an identifier for identifying the host computer, on which an application, such as IP address, starts; the SSVOL group ID 7002 indicating the volume for storing the snapshot; and obtaining time 7003 of the snapshot.

The setting program 1265 sets the corresponding relationship among the application ID 7004, the host address 7001, and the SSVOL group ID 7002.

The backup program 1263 sets a value of the obtaining time 7003, when the backup program 1263 obtains the snapshot based on the backup schedule designated by the manager. Incidentally, when the snapshot is not stored (in the initial state), 0 is set.

FIG. 8 shows an example of a storage table 8000 forming the backup management information 1264. The storage table 8000 comprises a storage ID 8001 and an IP address 8002. The storage ID 8001 holds an identifier for uniquely identifying the storage device, such as serial No. The IP address 8002 holds an address of a network of a management I/F. The manager sets both the two values via a GUI provided by the setting program 1265.

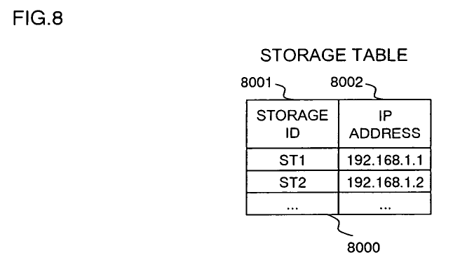

FIG. 9 shows an example of a rule table 9000 forming the recovery point management information 1031. The rule table 9000 comprises a JNL group ID 9001 and a rule 9002. The JNL group ID 9001 holds an identifier of the journal group, to which the rule is applied. The rule 9002 holds a character string indicating the contents of a rule defining file stored in the local disk 1260. The values are set by the setting program 1265.

(2) Operation According to First Embodiment

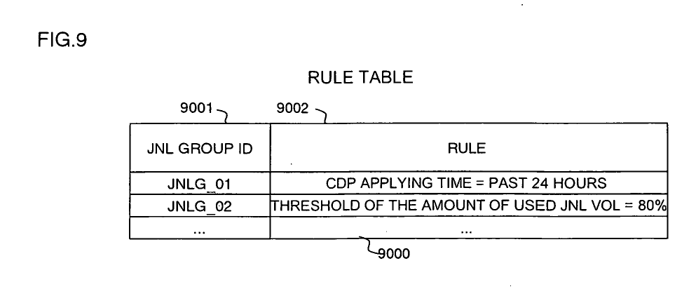

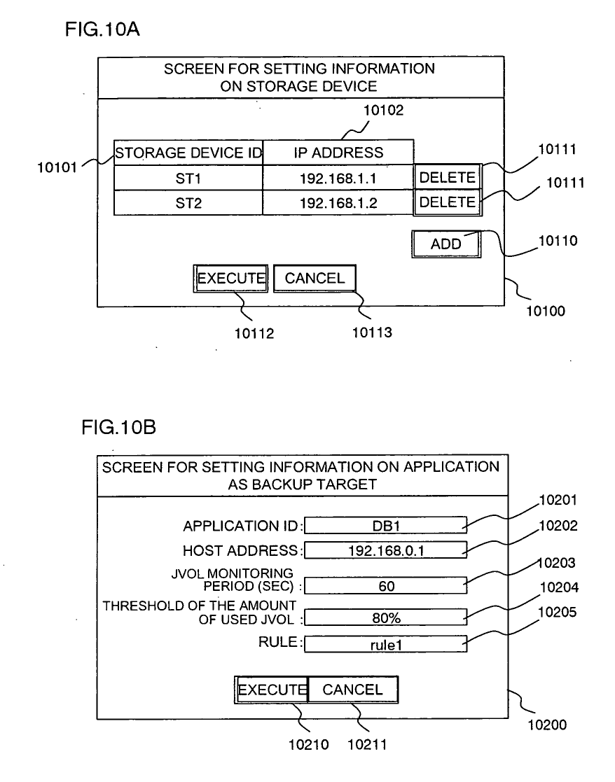

First, a description is given of the operation of the setting program 1265. FIGS. 10A and 10B show examples of a GUI for setting the system provided by the setting program 1265. A screen 10100 for setting information on the storage device shown in FIG. 10A is an example of a screen for request and display operation by a CLI on the setting program 1265, when the manager sets information on the storage device. A storage device ID 10101 is a field for inputting an ID for identifying the storage device, such s serial No. An IP address 10102 is a field for inputting an IP address for connection to the management I/F of the storage device indicated by the storage device ID 10101.

Add 10110, delete 10111, execute 10112, and cancel 10113 are buttons.

On the screen 10100 for setting information on the storage device, three of the storage device ID 10101, the IP address 10102, and the delete 10111 form one column. The delete 10111 is pressed and, then, the column of the pressed delete 10111 can be deleted from the screen 10100 for setting information on the storage device. The add 10110 is pressed and, then, the column can be increased on the screen 10100 for setting information on the storage device. The cancel 10113 is pressed and, then, the setting program 1265 ends without any operations. The execute 10112 is pressed and, then, the setting program 1265 sets a set of a value of the inputted storage device ID 10101 and a value of the IP address 10102 to the storage ID 8001 and the IP address 8002 of the storage table 8000.

A screen 10200 for setting information on the application as a backup target shown in FIG. 10B is an example of a screen for request and display operation by a CLI on the setting program 1265, when the manager sets information on the application as a backup target. An application ID 10201 is a field for uniquely inputting an application, serving as a backup target. A host address 10202 is a field for inputting an IP address of the host computer, on which the application, as a backup target, starts. A JVOL monitoring period (second) 10203 is a field for inputting a journal volume monitoring period. Here, although the unit is second, it may be a unit except for this. The threshold 10204 of the amount of used JVOL is a field for inputting a threshold, serving as trigger for executing the journal releasing. A rule 10205 is a field for inputting a rule defining file name stored in the local disk 1260. Execute 10210 and cancel 10211 are buttons.

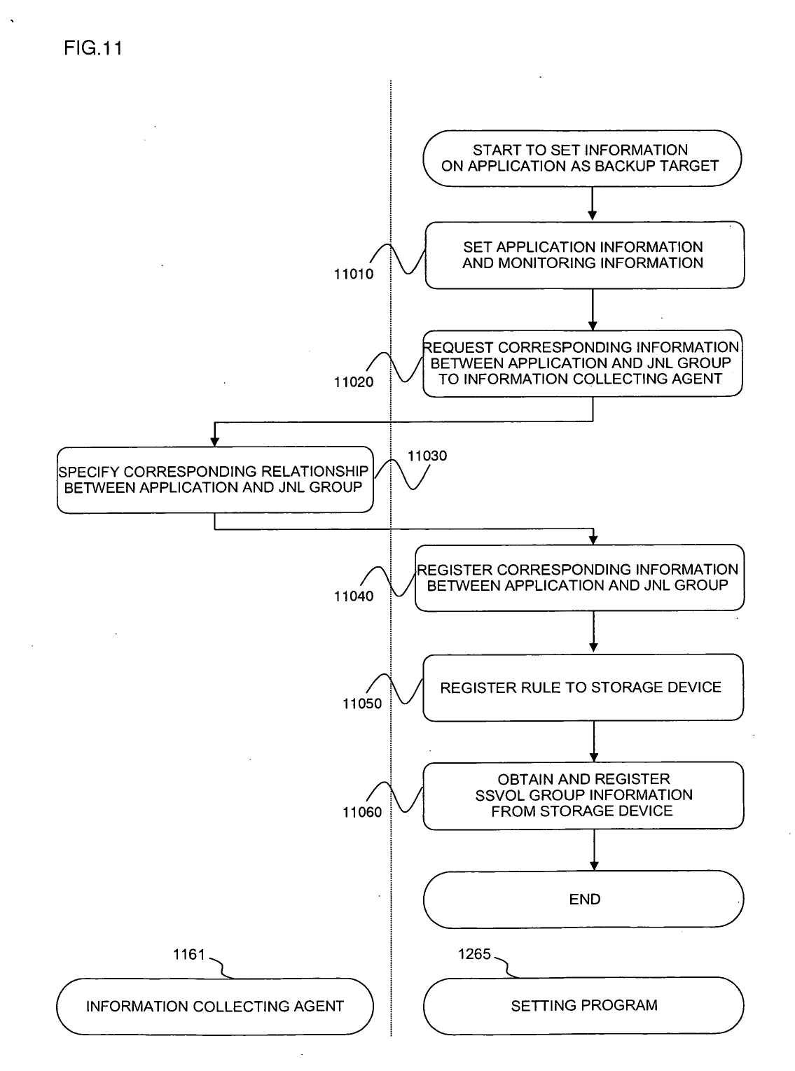

The cancel 10211 is pressed and, then, the setting program 1265 ends without any operations. The execute 10210 is pressed and, then, information is set in accordance with a flow shown in FIG. 11.

Hereinlater, a description is given of an example of the operation of the setting program 1265 upon pressing the button of the execute 10210 on the screen shown in FIG. 10B and of the information collecting agent 1161 which is called in the halfway by the setting program 1265 with reference to FIG. 11. First, the setting program 1265 sets a value of the application ID 10201 to an application ID 6001 of the application table 6000, a value of the host address 10202 to the host address 6002 of the application table 6000, a value of the JVOL monitoring period (second) 10203 to the JVOL monitoring period (second) 6005 of the application table 6000, a value of a threshold 10204 of the amount of used JVOL to the JVOL threshold 6006 of the application table 6000 (in step 11010).

Subsequently, the setting program 1265 is connected to the host computer indicated by the host address 6002, and requests the corresponding information between the application and the journal group to the information collecting agent 1161 (in step 11020).

The information collecting agent 1161 specifies the data volume used by the application from the system structure defining file stored in the local disk 1170, and further specifies the journal group of the data volume and the storage device of the journal group. After that, the information collecting agent 1161 returns an application identifier, an identifier of the journal group of the data volume used by the application, and an identifier of the storage device of the journal group to the setting program 1265 (in step 11030).

The setting program 1265 sets an identifier of the journal group of the data volume used by the application of the setting program 1265 to the JNL group ID 6004, and the storage device of the journal group to the storage ID 6003 (in step 11040).

Subsequently, an IP address of the management I/F of the storage device is obtained from the storage table 8000 by using a value of the storage ID 6003, as a key, a request for correlating the contents of the rule defining file indicated by the rule 10205 with a value of the JNL group ID 6004 and then to set the associated contents to the rule table 9000 is sent to the storage micro program 1028 (in step 11050).

Finally, the connection to the storage device is established, the corresponding relationship between the journal group 5001 and the SSVOL group ID 5002 in the snapshot table 5000 is obtained from the storage micro program 1028, and the obtained corresponding relationship is set to the snapshot management table 7000 (in step 11060). This is the operation of the setting program.

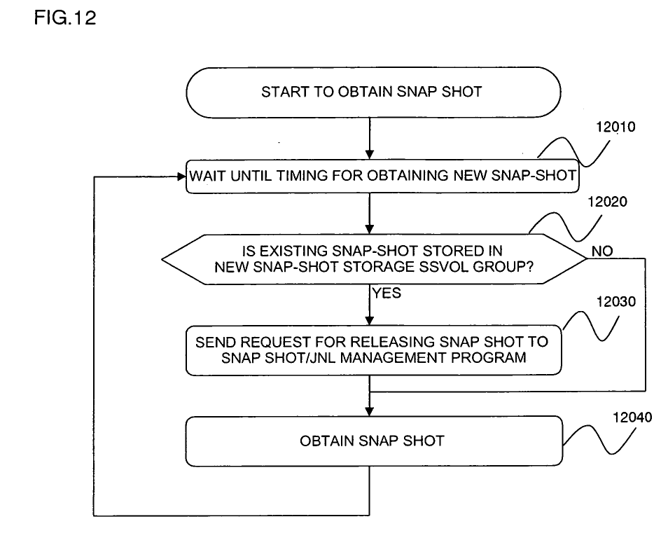

Hereinlater, a description is given of an example of the operation of the backup program 1263 with reference to FIG. 12. First, the backup program 1263 waits in accordance with the backup schedule until the timing for obtaining the snapshot (in step 12010).

At the timing for obtaining the snapshot, the backup program 1263 determines whether or not a new snapshot storage SSVOL group defined to the backup schedule stores the existing snapshot (in step 12020). Here, a value of the obtaining time 7003 of the snapshot management table 7000 is obtained by using an identifier of the new snapshot storage SSVOL group. When the value is 0, the backup program 1263 determines that the new snapshot storage SSVOL group does not store the existing snapshot. When the value is a number except for 0, the backup program 1263 determines that the new snapshot storage SSVOL group stores the existing snapshot.

When the existing snapshot is stored, a request for releasing the existing snapshot to sent to the snapshot/JNL management program 1030 (in step 12030). In this case, obviously, the IP address of the storage device, serving as the connecting destination can be calculated by using the application table 6000 and the storage table 8000. Incidentally, a description will be given of the operation of the snapshot/JNL management program 1030 upon receiving the request later. On the other hand, when the existing snapshot is not stored, step 12030 is skipped.

After that, the backup program 1263 obtains the new snapshot (in step 12040). Here, the processing corresponds to the issue of a series of requests on the conventional backup program, including the cancel of the acquisition and stop of the recovery manager 1162.

The acquisition of the new snapshot ends and, then, the processing returns to step 12010. The operation waits until the timing for obtaining the next snapshot. This is the operation of the backup program 1263.

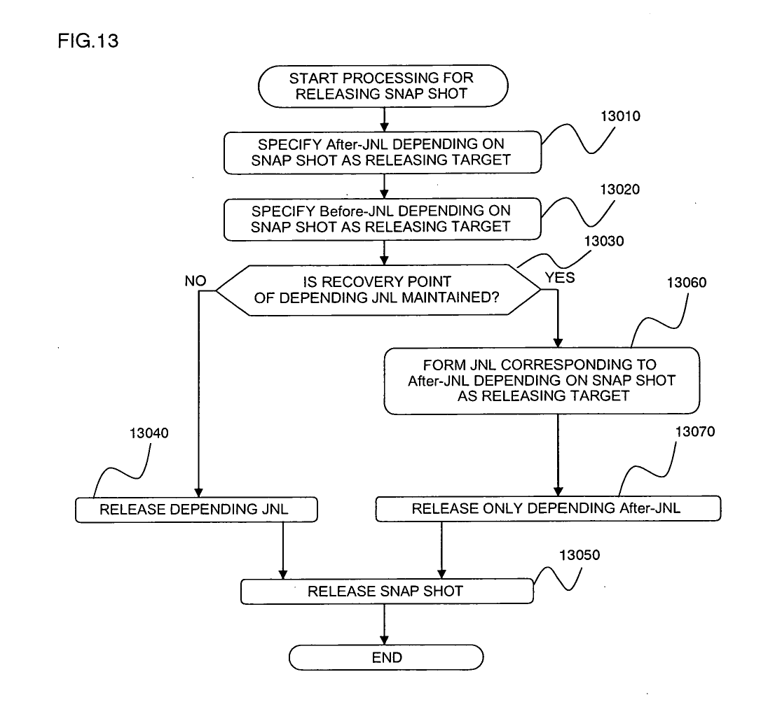

Hereinlater, a description is given of an example of the operation of the snapshot/JNL management program 1030, upon releasing the snapshot to the backup program 1263 with reference to FIG. 13.

First, the snapshot/JNL management program 1030 which receives a request for releasing the snapshot specifies the After journal depending on the snapshot as a releasing target (in step 13010). When another snapshot having the same image as that of the snapshot as a releasing target exists, or when the same image as that of the snapshot as a releasing target is formed by applying the After journal to a snapshot (hereinafter, referred to as “just-before snapshot”) older than the snapshot as a releasing target by one snapshot, the After journal which cannot be used by the release processing does not exist. In the case other than those, it is not possible to use the After journal having the recovery point before obtaining a snapshot (hereinafter, referred to as “just-after snapshot”) newer than the obtaining of the snapshot as a releasing target by one snapshot after obtaining the snapshot as a releasing target. The above-mentioned After journal becomes the After journal depending on the snapshot as a releasing target.

That is, when another snapshot having the same order number 5003 as that of the snapshot as a releasing target exists, the depending After journal does not exist. Further, when the just-before snapshot exists and the After journal having the same order number 2105 as the order number 5003 of the snapshot as a releasing target, the depending After journal does not exist. In the case other than this, the After journal having the order number 2105 which is larger than the order number 5003 of the snapshot as a releasing target and which is the order number of the just-after snapshot becomes the After journal depending on the snapshot as a releasing target. Incidentally, according to the first embodiment, it is assumed that the just-after snapshot exists. Further, according to another embodiment, when the just-after snapshot does not exist, all After journals having the order number 2105 larger than the order number 5003 of the snapshot as a releasing target become the After journal depending on the snapshot as a releasing target.

Subsequently, the Before journal depending on the snapshot as a releasing target is specified (in step 13020). Similarly to the above thinking, when another snapshot having the same image as that of the snapshot as a releasing target exists or, when the same image as that of the snapshot as a releasing target by applying the Before journal to the just-after snapshot, the Before journal which cannot be used by the release processing does not exist. On the other hand, in the case other than those, the Before journal having the recovery point from the obtaining of the just-before snapshot to the obtaining of the snapshot as a releasing target cannot be used. The above-mentioned Before journal becomes the Before journal depending on the snapshot as a releasing target.

That is, when the snapshot having the same order number 5003 as that of the snapshot as a releasing target exists, the depending Before-journal does not exist. Further, when the just-after snapshot exists and the Before journal having the same order number 2105 as the order number 5003 of the snapshot as a releasing target exists, the depending Before journal does not exist. In the case except for this, the Before journal having the order number 2105 which is the order number 5003 of the snapshot as a releasing target or less and which is larger than the order number 5003 of the just-before snapshot becomes the journal depending on the snapshot as a releasing target. Incidentally, when the just-before snapshot does not exist, all Before journals having the order number 2105 which is the order number 5003 of the snapshot as a releasing target or less become the Before journal depending on the snapshot as a releasing target.

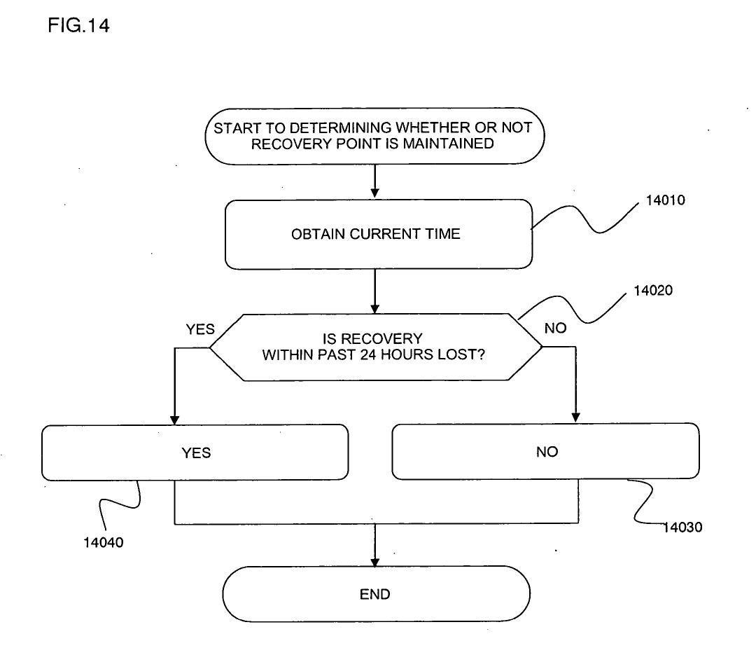

Subsequently, it is determined, by using a rule set to the rule 9002 of the rule table 9000, whether or not the corresponding journal is formed so as maintain the recovery point of the recovery point of the depending journal in the specified snapshot as a releasing target (in step 13030). FIG. 14 shows an example of processing in the case of setting “CDP applying time=past 24 hours”. This will be described later.

When it is determined that the recovery point is not maintained, a request for releasing the journal depending on the snapshot as a releasing target is sent to the storage micro program 1028 (in step 13040). With respect to the After journal in the journals depending on the snapshot as a releasing target, the storage micro program 1028 which receives the request sets NULL to the AJNL volume ID 2106 and the AJNL storage address 2107 of the journal header 2011 having the same order number 2105 as the order number of the journal. Further, with respect to the Before journal among the journals depending on the snapshot as a releasing target, the storage micro program 1028 sets NULL to a BJNL volume ID 2108 and the BJNL storage address 2109 of the journal header 2011 having the same order number 2105 as the order number of the journal.

Consequently, when all of the AJNL volume ID 2106, the AJNL storage address 2107, the BJNL volume ID 2108, and the BJNL storage address 2109 are NULL, the storage micro program 1028 releases the journal header 2011. After that, one of the journal headers 2011, having the smallest order-number 2105, is searched for, and the volume ID 4002 of the volume for storing the journal header the journal header 2011 is set to the oldest-JNL-header storing VOLID 3006. Further, an address for storing the journal header 2011 is set to the oldest-JNL-header storage address 3007.

Subsequently, a request for releasing the snapshot as a releasing target is sent to the storage micro program 1028 (in step 13050), and then the processing ends. The storage micro program 1028 which receives the request sets NULL to the order number 5003 and the obtaining time 5004 of the snapshot as a releasing target.

On the other hand, when it is determined in step 13030 that the recovery point is maintained, a request for forming the journal corresponding to the After journal depending on the snapshot as a releasing target is sent to the storage micro program 1028 (in step 13060). With respect to the After journal among the journals depending on the snapshot as a releasing target, the storage micro program 1028 which receives the request applies the After journal to the snapshot as a releasing target in accordance with the order number and saves data to be overwritten to the journal data area 2020. After that, the volume ID 4002 of the volume for storing the saved data is set every applied After journal to the BJNL volume ID 2108 the journal header 2011 in the After journal. Further, an address for storing the saved data is set to the BJNL storage address 2109 of the journal header 2011 in the After journal.

Subsequently, a request for releasing only the After journal depending on the snapshot as a releasing target is sent to the storage micro program 1028 (in step 13070). With respect to the After journal among the journals depending on the snapshot as a releasing target, the storage micro program 1028 which receives the request sets NULL to the AJNL volume ID 2106 and the AJNL storage address 2107 of the journal header 2011 having the same the order number 2105 as the order number of the journal.

Consequently, all of the AJNL volume ID 2106, the AJNL storage address 2107, the BJNL volume ID 2108, and the BJNL storage address 2109 are NULL, the storage micro program 1028 releases the journal header 2011. After that, the smallest order-number 2105 among the journal header 2011 is searched for, the volume ID 4002 of the volume for storing the journal header 2011 is set to the oldest JNL-header storing VOLID 3006. Further, an address for storing the journal header 2011 is set to the oldest-JNL-header storage address 3007. Here, the Before journal depending on the snapshot as a releasing target is not released because the same image as that of the snapshot as a releasing target is formed by applying the journal formed in step 13060 to the just-after snapshot and the Before journal depending on the snapshot as a releasing target becomes available again.

Finally, a request for releasing the snapshot as a releasing target is sent to the storage micro program 1028 (in step 13050) and, then, the processing ends.

The above-mentioned processing corresponds to the operation of the snapshot/JNL management program 1030, upon requesting the snapshot to the backup program 1263. Incidentally, FIG. 20A is a schematic diagram when it is determined that the recovery point of the depending journal is not maintained in step 13030 in the operation. As mentioned above the storage micro program 1028 releases the depending journal together with the releasing target. On the other hand, FIG. 20B is a schematic diagram when it is determined that the recovery point of the depending journal is maintained in step 13030 in the operation. As mentioned above, the storage micro program 1028 forms the depending Before-journal and thereafter releases the depending After-journal together with the releasing target.

Incidentally, according to the first embodiment, the operation is performed on the assumption that the just-after snapshot exists. According to another embodiment, when the assumption is not satisfied, the existence of the just-after snapshot is checked just before step 13060, when the just-after snapshot does not exist, the operation can be accomplished by adding determination for jump to step 13040.

Further, according to the first embodiment, it is assumed that the After journal is held so as to update the snapshot as a releasing target to the image of the just-after snapshot. When the assumption is not satisfied, the continuousness of the order numbers of the After journals between two snapshots is checked. When the order numbers are not continuous, the operation can be accomplished by adding determination for jump to step 13040 just before step 13060. That is, even when there is one of integers from a value obtained by adding one to the order number of the snapshot as a releasing target to the order number of the just-after snapshot, the operation can be accomplished by adding determination for jump to step 13040.

Hereinlater, a description is given of an example of the rule used in step 13030 in FIG. 13 with reference to FIG. 14. In the example, first, the current time is obtained (in step 14010). It is checked whether or not the recovery point within the past 24 hours from the time is lost (in step 14020). When the recovery point is not lost, it is determined that the recovery point is not maintained and is released (14030). When the recovery point is lost, it is determined that the recovery point is maintained (in step 14040). That is, this becomes a policy for making, effective, the recovery using the journaling as much as possible within the past 24 hours.

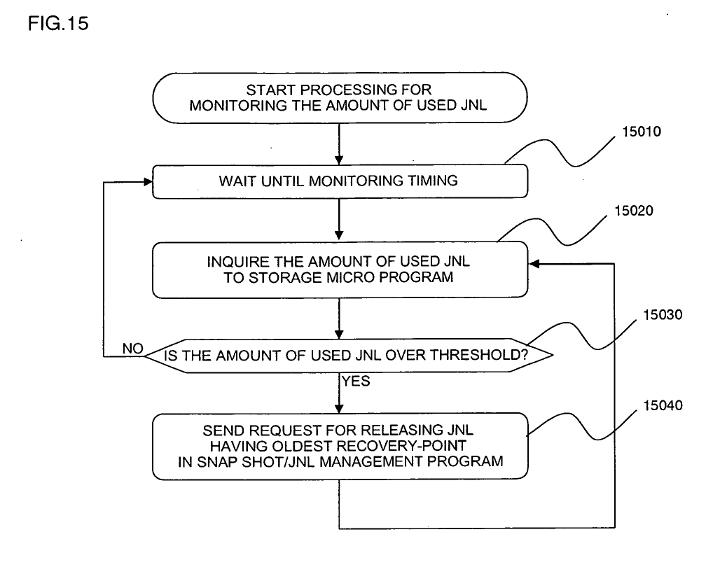

Hereinlater, a description is given of an example of the operation of the JNL releasing program 1262 with reference to FIG. 15. The JNL releasing program 1262 monitors and releases the amount of used journal at the interval set to the JVOL monitoring period (second) 6005 of the application table 6000. Until the timing, the JNL releasing program 1262 waits (in step 15010).

At the monitoring timing, the JNL releasing program 1262 obtains the IP address of the storage device used by the application as a backup target from the storage table 8000. The JNL releasing program 1262 is connected to the storage device by using the IP address, and inquires a using ratio of the journal to the storage micro program 1028 (in step 15020).

It is determined whether or not the obtained value is over the JVOL threshold 6006 of the application table 6000 (in step 15030). When the obtained value is over the JVOL threshold 6006, a request for releasing the journal having the oldest recovery-point (hereinafter, referred to as “the oldest journal”) among all journals to the snapshot/JNL management program is sent (in step 15040). After that, in order to check whether or not the amount of used journal is lower than the threshold by the journal releasing processing, the processing is jumped to step 15020 again.

When it is determined in step 15030 that the obtained value is not over the JVOL threshold 6006, the processing is jumped to step 14010 so as to wait until the next monitoring period. This is the operation of the JNL releasing program 1262.

Incidentally, the JNL releasing program periodically obtains the amount of used journal. When the amount of used journal is over the threshold, a request for releasing the oldest journal is sent to the snapshot/JNL management program 1030. Or, the manager, such as a CLI, can execute only a function for sending a request for releasing the oldest journal to the snapshot/JNL management program 1030. The manager can manage the journal by this.

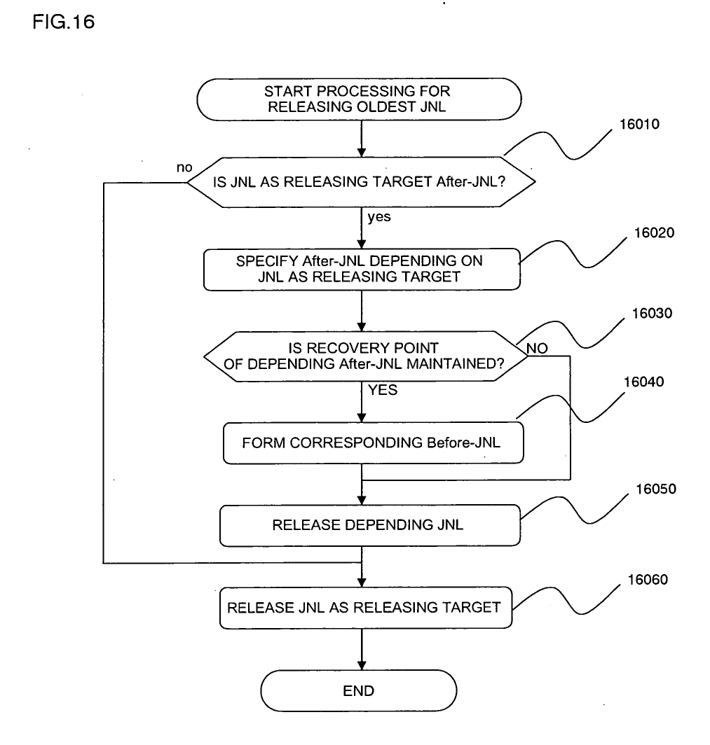

FIG. 16 shows an example of the flow showing the operation the snapshot/JNL management program 1030, when the JNL releasing program 1262 request the releasing processing of the oldest journal in step 15040 in FIG. 15.

The snapshot/JNL management program 1030 receives the request and, then, determines whether or not the oldest journal, as the journal as a releasing target, is the After journal (in step 16010). Here, the journal header of the smallest order-number is specified and it is checked whether or not the journal header has the journal data of the After journal. When it is determined that the journal header has the journal data of the After journal, it is determined that the oldest journal is the After journal. When it is determined that the journal header does not have the journal data of the After journal, it is determined that the oldest journal is the Before journal.

When it is determined that the journal data is the After journal, the After journal depending on the journal as a releasing target is specified (in step 16020). The release of the journal as a releasing target does not enable the use of the After journal having the recovery point before obtaining the first snapshot (hereinafter, referred to as “next snapshot”) having the recovery point of a newer recovery point of the oldest journal, except for the recovery point of the oldest journal. The above-mentioned After journal becomes the After journal depending on the journal as a releasing target.

That is, all After journals having, as the order No. 2015, integers from a value obtained by adding one to the order number 2105 of the journal as a releasing target to the order number 5003 of the next snapshot become the After journals depending on the journal as a releasing target.

Subsequently, it is determined, by using a rule set to the rule 9002 of the rule table 9000, whether or not the recovery point of the specified After journal is maintained (in step 16030). An example of the rule has been already described with reference to FIG. 14.

When it is determined that the recovery point is maintained, the corresponding journal is formed to the specified After journal (in step 16040). Here, the corresponding Before journal is formed by applying the journal as a releasing target and the After journal depending on the journal as a releasing target to the just-before snapshot of the journal as a releasing target. After that, the formed Before journal is applied to the snapshot and a request for returning the snapshot to be original is sent to the storage micro program 1028. With the After journal depending on the journal as a releasing target and the snapshot as a releasing target, the storage micro program 1028 which receives the request saves the data to be overwritten to the journal data area 2020 in accordance with the order number by applying the After journal to the just-before snapshot. After that, a volume ID 4002 of the volume for the saved data is set to the BJNL volume ID 2108 of the journal header 2011 in the After journal every applied After journal. Further, an address for storing the saved data is set to the BJNL storage address 2109 of the journal header 2011 in the After journal. Thus, it is possible to use the Before journal corresponding to the After journal depending on the journal as a releasing target and journal as a releasing target. After that, the snapshot is returned to be original by applying the available Before journal to the just-before snapshot. Further, a request for deleting the journal corresponding to the journal as a releasing target is sent to the storage micro program 1028. The storage micro program 1028 which receives the request sets NULL to the BJNL volume ID 2108 and the BJNL storage address 2109 of the journal header 2011 having the order number 2105 of the journal as a releasing target.

Subsequently, a request for releasing all the journals depending on the journal as a releasing target is sent to the storage micro program 1028 (in step 16050).

Finally, a request for releasing the oldest journal without updating the just-before snapshot is sent to the storage micro program 1028 (in step 16060). With respect to the After journal among the journals depending on the snapshot as a releasing target, the storage micro program 1028 which receives the request sets NULL to the AJNL volume ID 2106 and the AJNL storage address 2107 of the journal header 2011 having the same order number 2105 as the order number of the journal.

Consequently, when all of the AJNL volume ID 2106, the AJNL storage address 2107, the BJNL volume ID 2108, the BJNL storage address 2109 are NULL, the storage micro program 1028 releases the journal header 2011. After that, one of the journal headers 2011 having the smallest order-number 2105 is searched for, and the volume ID 4002 of the volume for storing the journal header 2011 is set to the oldest-JNL-header storing VOLID 3006. Further, an address for storing the journal header 2011 is set to the oldest-JNL-header storage address 3007.

When it is determined in step 16010 that the oldest journal is the Before journal, the journal depending on the journal as a releasing target does not exist. Therefore, steps 16020 to 16050 are skipped and only the Before journal is released (in step 16060).

This is an example of the operation of the snapshot/JNL management program 1030 upon sending a request for releasing the oldest journal from the JNL releasing program 1262. Incidentally, FIG. 19A is a schematic diagram in the case of determining in step 16030 of the operation that the recovery point of the depending After journal is not maintained. As mentioned above, the storage micro program 1028 releases the depending journal together with the releasing target. On the other hand, FIG. 19B is a schematic diagram in the case of determining in step 16030 of the operation that the recovery point of the depending After journal is maintained. As mentioned above, the storage micro program 1028 releases the depending After journal is released together with the releasing target after forming the depending Before journal.

Incidentally, when the oldest journal is released and thus the previous snapshot is not necessary, the previous snapshot may be not released without returning the snapshot to the original state in step 15050. However, in this case, a flag for determining whether or not the previous snapshot is necessary is added to the snapshot table 5000, and a value needs to be set.

Further, the journal releasing processing may select the conventional approach. However, in this case, a flag for determining by which approach the journal is released is added to the rule table 9000 and a value needs to be set. Then, the determination for determining the use of the conventional approach is added before step 15010, thereby realizing the processing.

Furthermore, according to the first embodiment, such a holding procedure of the After journal is assumed that the snapshot just before the journal as a releasing target needs to be updated to the image of the next snapshot. When the assumption is not satisfied, the continuousness between the order numbers of the After journals between the two snapshots is confirmed just before step 16040. When it is determined that the continuousness is not established, the processing is jumped to step 16050, thereby realizing this. That is, when even one of integers from a value obtained by incrementing the order number of the just-before snapshot to the order number of the just-after snapshot is not the order number of the After journal, the processing is jumped to step 16050, thereby realizing this.

As mentioned above, according to the first embodiment, since unavailable journal does not remain in the journal volume upon releasing the journal or snapshot, the journal can be efficiently used.

### Second Embodiment

(1) System Structure According to Second Embodiment

FIG. 17 shows a diagram of the system structure according to a second embodiment of the present invention. The structure is mainly the same as that according to the first embodiment and different points are therefore described. With the structure, a main memory 1201 of the storage device 1000 stores a writing monitoring program 1032. The writing monitoring program 1032 monitors the writing operation from the host computer 1100, and ensures a journal storage area just before forming the journal of the storage micro program 1028. With the structure, the memory 1250 of the management computer 1200 does not store the JNL releasing program. In accordance therewith, the JVOL monitoring period (second) 6005 and the JVOL threshold 6006 of the application table 6000 are not used and, therefore, those may be deleted.

(2) Operation According to Second Embodiment

A description is mainly given of different points because the operation according to the second embodiment is almost the same as that according to the first embodiment. In the operation of the setting program 1265, the JVOL monitoring period (second) 10203 and the threshold 10204 of the amount of used JVOL do not need to be displayed on a screen 10200 for setting the application as a backup target. Further, in accordance therewith, step of setting the values of the two fields to the application table 6000 from step 11010 in FIG. 11 can be omitted.

Hereinlater, a description is given of an example of the operation of the writing monitoring program 1032 with reference to FIG. 18. First, the writing monitoring program 1032 waits until the writing operation from the host computer 1100 reaches the storage device 1000 (in step 18010). When the writing operation reaches the storage device 1000, the writing monitoring program 1032 performs the control operation before the storage micro program 1028 forms a new journal, and inquires the total amount of the journal volume 1013 and the amount of used journal to the storage micro program 1028 (in step 18020). Obviously, the storage micro program 1028 calculates the values from the journal volume table 4000 and the journal header 2011.

Subsequently, the length of the written data is obtained from the writing request, the total of journal volume and the amount of used journal volume is determined so as to check a room for forming the journal header and the journal data (in step 18030).

When it is determined that the room for forming the journal header and the journal data exists, the control operation is returned to the storage micro program 1028 (in step 18040), and the storage micro program 1028 waits until generating the neat writing operation (in step 18010).

On the other hand, when it is determined that the room for forming the journal header and the journal data does not exist, a request for releasing the oldest journal to the snapshot/JNL management program 1030 is sent (in step 18050). Incidentally, the operation of the snapshot/JNL management program 1030 which responds to this request is the same as that described above with reference to FIG. 16. After that, in order to check whether or not there is a room for forming the journal as the releasing result, the processing returns to step 18020. This is the operation of the writing monitoring program 1032.

As mentioned above, according to the second embodiment, since unavailable journal does not remain in the journal volume upon releasing the journal or snapshot synchronized with the writing from the host computer, the journal can be efficiently used.

The foregoing has been described according to the first and second embodiments of the present invention. According to another embodiment of the above-mentioned first and second embodiments of the present invention, in a computer system, the storage system determines whether or not the recovery point of the depending journal is maintained.

According to another embodiment of the above-mentioned first and second embodiments of the present invention, in a computer system, the storage system determines that the recovery point of the depending journal is maintained, saves data overwritten upon applying the journal depending on the snapshot as a releasing target to the snapshot as a releasing target, and maintains the recovery point of the journal depending on the snapshot as a releasing target.

According to another embodiment of the above-mentioned first and second embodiments of the present invention, in a computer system, the storage system determines that the recovery point of the depending journal is maintained. In the computer system, data overwritten upon applying the journal depending on the snapshot, to which the journal as a releasing target is to be applied, to the snapshot is saved. The recovery point of the journal depending on the snapshot, to which the journal as a releasing target is to be applied, is maintained.

According to another embodiment of the above-mentioned first and second embodiments of the present invention, in a computer system, the management computer determines whether or not the amount of used journal is over a predetermined value. When it is determined that the amount of used journal is over a predetermined value, a request for releasing the oldest journal is sent to the storage system.

According to another embodiment of the above-mentioned first and second embodiments of the present invention, in a computer system, the management computer sends a request for obtaining the snapshot and for releasing the oldest snapshot to the storage system.

According to another embodiment of the above-mentioned first and second embodiments of the present invention, a storage system comprises a disk device having a data volume for reading and writing data by one or a plurality of host computers. The host computer and a management computer form a computer system. The storage system comprises a CPU, a memory, and a connecting interface, and obtains a snapshot of the data volume at a specific time point, holds the written journal after the specific time point, recovers the snapshot with the snapshot obtained at the time point near a recovery point, as the base, in the recovery, by applying the journal to the snapshot, specifies the journal depending on the snapshot or journal as a releasing target by using an order relationship used for determining the order between the snapshot, serving as the base, in the recovery, and the journals applied to the snapshot upon releasing the snapshot or journal, and releases the specified depending journal together with the snapshot or journal as a releasing target.

According to another embodiment of the above-mentioned first and second embodiments of the present invention, a storage system determines whether or not the recovery point of the depending journal is maintained.

According to another embodiment of the above-mentioned first and second embodiments of the present invention, a storage system determines that the recovery point of the depending journal is maintained, saves data overwritten upon applying the journal depending on the snapshot as a releasing target to the snapshot as a releasing target, and maintains the recovery point of the journal depending on the snapshot as a releasing target.

According to another embodiment of the above-mentioned first and second embodiments of the present invention, a storage system determines that the recovery point of the depending journal is maintained, saves data overwritten upon applying the journal depending on the snapshot, to which the journal as a releasing target is to be applied, to the snapshot, and maintains the recovery point of the journal depending on the snapshot, to which the journal as a releasing target is to be applied.

According to another embodiment of the above-mentioned first and second embodiments of the present invention, a management computer is connected to a storage system, the storage system comprises one or a plurality of host computers and a disk device having a data volume for writing and reading data by the host computer. The storage system releases a snapshot or a journal as a releasing target and a depending journal. The management system comprises a CPU, a memory, and a connecting interface, determines whether or not the amount of used journal to be held by said storage system is over a predetermined value, when the amount of used journal is over a predetermined value, and sends a request for releasing the oldest journal to said storage system.

According to another embodiment of the above-mentioned first and second embodiments of the present invention, a management computer sends a request for obtaining the snapshot and releasing the oldest snapshot to the storage system.

According to another embodiment of the above-mentioned first and second embodiments of the present invention, in backup management method of a computer system, the computer system comprises one or a plurality of host computers, a storage system comprises a disk device having a data volume for writing and reading data by the host computer, and a management computer for connecting the host computer and the storage system. The backup management method comprises the steps of: specifying a journal depending on a snapshot or journal as a releasing target by using an order relationship used for determining the order between the snapshot, serving as the base, in the recovery upon releasing the snapshot or journal; and releasing the specified journal together with the snapshot or journal as a releasing target.

According to another embodiment of the above-mentioned first and second embodiments of the present invention, a backup management method comprises the step of determining whether or not the recovery point of the depending journal is maintained.

According to another embodiment of the above-mentioned first and second embodiments of the present invention, a backup management method comprises the steps of: determining whether or not the recovery point of the depending journal is maintained; saving data overwritten upon applying the journal depending on the snapshot as a releasing target to the snapshot as a releasing target; and maintaining the recovery point of the journal depending on the snapshot as a releasing target.

According to another embodiment of the above-mentioned first and second embodiments of the present invention, a backup management method comprises the steps of: determining whether or not the recovery point of the depending journal is maintained; saving data overwritten upon applying the journal depending on the snapshot as a releasing target, to which the journal as a releasing target is to be applied; and maintaining the recovery point of the journal depending on the snapshot as a releasing target, to which the journal as a releasing target is to be applied.

According to another embodiment of the above-mentioned first and second embodiments of the present invention, a backup management method comprises the step of: determining whether or not the amount of used journal is over a predetermined value and sending a request for releasing the oldest journal to the storage system when it is determined the amount of used journal is over the predetermined value.

According to another embodiment of the above-mentioned first and second embodiments of the present invention, a backup management method comprises the step of: sending a request for obtaining the snapshot to the storage system and releasing the oldest snapshot.

What is claimed is:

1. A computer system comprising one or a plurality of host computers, a storage system comprising a disk device having a data volume for reading and writing data by said host computer, and a management computer for connecting said host computer and said storage system,
wherein said storage system obtains a snapshot of the data volume at a specific time point, holds the written journal after the specific time point, recovers, the snapshot with the snapshot obtained at the time point near a recovery point, as the base, in the recovery, by applying the journal to the snapshot, specifies the journal depending on the snapshot or journal as a releasing target by using an order relationship used for determining the order between the snapshot, serving as the base, in the recovery, and the journals applied to the snapshot upon releasing the snapshot or journal, and releases the specified depending journal together with the snapshot or journal as a releasing target.

2. A computer system according to claim 1, wherein said storage system determines whether or not the recovery point of the depending journal is maintained.

3. A computer system according to claim 1, wherein said storage system determines that the recovery point of the depending journal is maintained, saves data overwritten upon applying the journal depending on the snapshot as a releasing target to the snapshot as a releasing target, and maintains the recovery point of the journal depending on the snapshot as a releasing target.

4. A computer system according to claim 1, wherein said storage system determines that the recovery point of the depending journal is maintained, saves data overwritten upon applying the journal depending on the snapshot, to which the journal as a releasing target is to be applied, to the snapshot, and maintains the recovery point of the journal depending on the snapshot, to which the journal as a releasing target is to be applied.

5. A computer system according to claim 1, wherein said management computer determines whether or not the amount of used journal is over a predetermined value and, when it is over the predetermined value, sends a request for releasing the oldest journal to said storage system.

6. A computer system according to claim 1, wherein said management computer sends a request for obtaining the snapshot to said storage system and for releasing the oldest snapshot.

7. A storage system comprising a disk device having a data volume for reading and writing data by one or a plurality of host computers, said host computer and a management computer forming a computer system,
wherein said storage system comprises a CPU, a memory, and a connecting interface, and obtains a snapshot of the data volume at a specific time point, holds the written journal after the specific time point, recovers the snapshot with the snapshot obtained at the time point near a recovery point, as the base, in the recovery, by applying the journal to the snapshot, specifies the journal depending on the snapshot or journal as a releasing target by using an order relationship used for determining the order between the snapshot, serving as the base, in the recovery, and the journals applied to the snapshot upon releasing the snapshot or journal, and releases the specified depending journal together with the snapshot or journal as a releasing target.

8. A storage system according to claim 7, wherein said storage system determines whether or not the recovery point of the depending journal is maintained.

9. A storage system according to claim 7, wherein said storage system determines that the recovery point of the depending journal is maintained, saves data overwritten upon applying the journal depending on the snapshot as a releasing target to the snapshot as a releasing target, and maintains the recovery point of the journal depending on the snapshot as a releasing target.

10. A storage system according to claim 7, wherein said storage system determines that the recovery point of the depending journal is maintained, saves data overwritten upon applying the journal depending on the snapshot, to which the journal as a releasing target is to be applied, to the snapshot, and maintains the recovery point of the journal depending on the snapshot, to which the journal as a releasing target is to be applied.

11. A management computer connected to a storage system, said storage system comprising one or a plurality of host computers and a disk device having a data volume for writing and reading data by said host computer, said storage system releasing a snapshot or a journal as a releasing target and a depending journal,
wherein said management system comprises a CPU, a memory, and a connecting interface, determines whether or not the amount of used journal to be held by said storage system is over a predetermined value, when the amount of used journal is over a predetermined value, and sends a request for releasing the oldest journal to said storage system.

12. A management computer according to claim 11, wherein said management computer sends a request for obtaining a snapshot and for releasing the oldest snapshot to said storage system.

13. A backup management method of a computer system, said computer system comprising one or a plurality of host computers, a storage system comprising a disk device having a data volume for writing and reading data by said host computer, and a management computer for connecting said host computer and said storage system,
said backup management method comprising the steps of:
specifying a journal depending on a snapshot or journal as a releasing target by using an order relationship used for determining the order between the snapshot, serving as the base, in the recovery upon releasing the snapshot or journal; and
releasing the specified journal together with the snapshot or journal as a releasing target.

14. A backup management method according to claim 13, further comprising the step of:
determining whether or not the recovery point of the depending journal is maintained.

15. A backup management method according to claim 13, further comprising the steps of:
determining whether or not the recovery point of the depending journal is maintained;
saving data overwritten upon applying the journal depending on the snapshot as a releasing target to the snapshot as a releasing target; and
maintaining the recovery point of the journal depending on the snapshot as a releasing target.

16. A backup management method according to claim 13, further comprising the steps of:
determining whether or not the recovery point of the depending journal is maintained;
saving data overwritten upon applying the journal depending on the snapshot as a releasing target, to which the journal as a releasing target is to be applied; and
maintaining the recovery point of the journal depending on the snapshot as a releasing target, to which the journal as a releasing target is to be applied.

17. A backup management method according to claim 13, further comprising the steps of:
determining whether or not the amount of used journal is over a predetermined value; and
sending a request for releasing the oldest journal to said storage system, upon determining that the amount of used journal is over the predetermined value.

18. A backup management method according to claim 13, further comprising the steps of:
sending a request for obtaining the snapshot and releasing the oldest snapshot to said storage system.
